(19) United States
(12) Patent Application Publication
(10) Pub. No.: US 2026/0219232 A1
(43) Pub. Date: Jul. 30, 2026

(54) METHOD AND SYSTEM FOR CHECKING AND EVALUATION OF ACTIVATION OF POROUS MATERIALS

(71) Applicant: SK EMBIO DIAGNOSTICS LIMITED, Nicosia (CY)

(72) Inventors: Theophylactos APOSTOLOU, Nicosia (CY); Constantinos LOIZOU, Nicosia (CY); Agni HADJILOUCA, Nicosia (CY)

(21) Appl. No.: 19/158,370

(22) PCT Filed: Feb. 23, 2024
(86) PCT No.: PCT/EP2024/054611

§ 371 Date: Aug. 20, 2025

(30) Foreign Application Priority Data
Mar. 3, 2023 (CY) CY202300001

(51) Int. Cl. G01N 27/416; G06N 20/00

(52) U.S. Cl. CPC G01N 27/416; G06N 20/00

(57) ABSTRACT

The method and system of the present invention relies on measuring actual porous material performance, in particular GAC performance on the basis of the obtained redox potential reading. The measurement data are uploaded to a cloud server where machine-learning algorithms process and interpret the obtained readings. The method and system proposed is easy to use anywhere and by anyone, the test is simple, quick and does not require laboratory conditions. Results are available almost immediately.

### TECHNICAL FIELD OF THE INVENTION

The invention belongs to the field of checking and evaluation of activation of porous materials, such as granular active carbon (GAC), zeolites and porous ceramic used in filters. The invention combines the technical fields of chemistry, electronics, telecommunications, and computer science.

Some examples of porous materials that are commonly used in water and/or air filtration:
1. Activated carbon: used in both water and air filters, often in combination with other materials, to remove impurities and pollutants such as volatile organic compounds (VOCs), chlorine, and pesticides.
2. Zeolites: used in water filters to remove heavy metals such as lead and arsenic, as well as other impurities such as ammonia.
3. Silica gel: often used in small-scale air filters to absorb moisture and prevent mold growth.
4. Porous ceramic filters: commonly used in water filters to remove bacteria, parasites, and other contaminants.
5. Porous polyethylene filters: commonly used in air filtration to capture particles such as dust, pollen, and pet dander.
6. Carbon block filters: used in water filtration systems to remove chlorine, sediment, and other contaminants.

### INTRODUCTION, TECHNICAL PROBLEM SOLVED

Traditional methods for evaluating porous material performance, as for instance used in a filter, involve measuring the porosity of the filter material used through the adsorption of specific substances. Those methods do not necessarily provide a precise measure of the material's ability to absorb other substances, leading to false results. Traditional methods require special laboratory equipment and facilities, with a long process time, as well as specially trained staff.

A particular problem arises when the field of application is water purification and the sewage industry. Inappropriate, complex, lab-requiring methods to evaluate whether a porous material filter is activated or not, are a source of uncertainty and complexity in these cases.

It is important to check if a porous material, as for instance used in a filter, is activated because the adsorption capacity of the material is directly related to its degree of activation. Activated carbon filters, for example, are commonly used to purify air and water by adsorbing impurities onto their porous surface. However, the effectiveness of the filter depends on the extent of the pore development, which in turn depends on the activation process used to prepare the material used for the filtering process. If the material is not activated to a sufficient degree, it may not be able to remove the impurities effectively, which can lead to poor air or water filtration and potentially harmful health effects.

By testing if a porous material, as for instance used in a filter, is activated, one can ensure that the filter is working effectively and efficiently. In industrial or environmental applications, where the quality of air or water is critical to the health and safety of workers or the public, it is particularly important to ensure that the material used in the filter is activated properly.

Furthermore, knowing the degree of activation can also help in optimizing the filter design and operation for maximum efficiency and effectiveness.

There are several techniques to check if porous materials are activated, such as:
1. Brunauer-Emmett-Teller (BET) analysis: This technique measures the specific surface area of a material and is commonly used to quantify the porosity and degree of activation of a material. BET analysis involves measuring the amount of gas that is adsorbed onto the material's surface, allowing the calculation of the surface area of the material.
2. Pore size distribution analysis: This technique analyzes the distribution of pore sizes in the material. This method can be used to determine the specific pore sizes that are present in the activated material.
3. Scanning Electron Microscopy (SEM): This technique uses high-resolution microscopy to examine the surface of the material. It can be used to visualize the surface of the activated material and assess its porous structure.
4. X-ray diffraction (XRD): This technique measures the crystal structure of the material and can be used to determine the degree of activation of the material. XRD is a useful technique in the case of activated carbon that has a well-defined crystalline structure.

These techniques are commonly used to evaluate the degree of activation of a material and to assess its pore size distribution and surface area. By using these methods, it is possible to determine if a porous material has been activated, and to what extent.

In the specific case of granular active carbon filters, the general method to check if activated carbon is still effective, are:
1. Scanning Electron Microscopy (SEM): SEM can be used to examine the surface morphology of the carbon material. Activated carbon typically has a porous structure, so SEM can be used to assess the extent of the pore development and degree of activation.
2. Iodine Number Test: This test measures the surface area of the activated carbon by determining the amount of iodine adsorbed by the material. The test involves mixing the activated carbon with a known concentration of iodine solution, allowing the iodine to adsorb onto the carbon material, and then measuring the amount of iodine that was adsorbed.
3. BET Analysis: BET analysis measures the specific surface area of the activated carbon. The technique involves adsorbing a gas onto the carbon surface, and then calculating the surface area from the amount of gas adsorbed.
4. Molasses Number Test: The molasses number test is a measure of the adsorptive properties of activated carbon. The test involves mixing activated carbon with a solution of molasses, which is then stirred and allowed to settle. The amount of molasses remaining in the solution is a measure of the adsorption capacity of the activated carbon.
5. Methylene Blue Adsorption Test: This test measures the pore size distribution and surface area of activated carbon. It involves adding methylene blue dye to the carbon material, measuring the amount of dye adsorbed, and then calculating the surface area and pore volume from the amount of dye adsorbed.

Overall, these techniques for carbon activation evaluation can be used to assess activation of carbon materials and to quantify their adsorptive properties. The choice of technique depends on the specific characteristics of the carbon material being tested and the type of information required.

In conclusion, there is a lack of practical equipment, such as portable tools, for quickly and accurately monitoring whether a porous material is activated. In the specific case of carbon, the inability to check whether activated carbon is still effective, can lead to several problems or issues, including:

Reduced efficiency: if activated carbon is no longer effective, it will not absorb pollutants or impurities. This can lead to reduced efficiency of industrial processes that rely on activated carbon for purification, such as water treatment and air purification.

Increased costs: if activated carbon is not performing as expected, it may need to be replaced more frequently, leading to increased costs for the industrial process that relies on it. Without regular testing to determine the degree of activation of the activated carbon, it may be difficult to identify when it needs to be replaced, leading to higher costs.

Environmental impact: ineffective activated carbon may allow pollutants and impurities to pass through the purification process and be released into the environment. This can lead to negative environmental impacts, such as water and air pollution, which can be harmful to human health and ecosystems.

Health impact: ineffective activated carbon may allow pollutants and impurities to pass through the purification process and be allowed to reach home water supplies, leading to health risks.

Therefore, it is important to regularly test the activation of porous materials, in particular activated carbon, to ensure its effectiveness and prevent the above-mentioned problems or issues.

### State of the Art

Document Sinha et al. “Surface area determination of porous materials using the Brunauer-Emmett-Teller (BET) method: limitations and improvements.” The Journal of Physical Chemistry C 123.33 (2019): 20195-20209, discloses the Brunauer-Emmett-Teller (BET) method for surface area determination of porous materials. The solution proposed comes with some advantages and disadvantages.

### Advantages:

Can provide accurate surface area measurements
Suitable for a wide range of materials
Easy to use and relatively fast results

### Disadvantages:

Does not provide information about the pore size distribution.
Requires a high vacuum environment and expensive equipment

Document Lastoskie et al. “Pore size distribution analysis of microporous carbons: a density functional theory approach.” The journal of physical chemistry 97.18 (1993): 4786-4796 discloses the determination of Pore Size Distribution (PSD) of porous sorbents. The solution proposed comes with some advantages and disadvantages.

### Advantages:

Can provide detailed information about the pore size distribution of a material
Can identify pore blocking or other issues.
Helps to predict the performance of the material

### Disadvantages:

Requires complex analysis and advanced equipment
Limited to specific pore sizes
The accuracy depends on the quality of the model used

Document Stevens et al. “An appraisal of high-resolution scanning electron microscopy applied to porous materials.” JEOL news 44.1 (2009): 17-22, discloses the use of Scanning Electron Microscopy (SEM) on porous materials. The solution proposed comes with some advantages and disadvantages.

### Advantages:

Can provide high-resolution images of the surface structure of the material
Can reveal information about the morphology of the material
Can be used to study the changes in the pore structure of the material

### Disadvantages:

Expensive and complex equipment required.
Cannot provide quantitative information about the surface area or pore size distribution.
Time-consuming and sample preparation can be challenging

Document Ishii et al. “Pore size determination in ordered mesoporous materials using powder X-ray diffraction.” The Journal of Physical Chemistry C 117.35 (2013): 18120-18130, discloses a method for the determination of pore size in mesoporous materials using Powder X-ray Diffraction (XRD). The solution proposed comes with some advantages and disadvantages.

### Advantages:

Can determine the degree of crystallinity of the material
Can detect any changes in crystal structure due to activation
Relatively fast and non-destructive

### Disadvantages:

Expensive equipment and requires highly trained personnel
Cannot provide direct information about the surface area or pore size distribution.
Limited to materials with a well-defined crystalline structure

Document Achaw et Osei-Wusu, “A study of the porosity of activated carbons using the scanning electron microscope.” Scanning electron microscopy. IntechOpen, 2012, discloses a study of the porosity of activated carbons using the Scanning Electron Microscope (SEM). The solution proposed comes with some advantages and disadvantages.

### Advantages:

Can provide high-resolution images of the carbon material's surface morphology.
Can reveal information about the degree of pore development and degree of activation
Can be used to study the changes in the pore structure of the material

### Disadvantages:

Expensive and complex equipment required
Cannot provide direct information about the surface area or pore size distribution
Time-consuming and sample preparation can be challenging

Document ASTM D4607-94 (Reapproved 2017), Standard Test Method for Determination of Iodine Number of Activated Carbon, ASTM International, West Conshohocken, PA, 2017, (www.astm.org.) discloses the standard test method (ASTM D4607-94) for the determination of the iodine number of activated carbon. The solution proposed comes with some advantages and disadvantages.

### Advantages:

Can provide a measure of the surface area of the carbon material
Simple and straightforward to perform.
Relatively inexpensive

### Disadvantages:

Can be affected by the presence of other substances that can compete with the iodine for adsorption sites
The test is not highly precise

Document Kacan Erdal. “Optimum BET surface areas for activated carbon produced from textile sewage sludges and its application as dye removal.” Journal of environmental management 166 (2016): 116-123 discloses the determination of the optimum preparation conditions for activated carbons using Brunauere-Emmelte-Teller (BET) analysis. The solution proposed comes with some advantages and disadvantages.

### Advantages:

Provides an accurate measure of the specific surface area of the carbon material
Suitable for a wide range of carbon materials
Easy to use and relatively fast results

### Disadvantages:

Does not provide information about the pore size distribution.
Requires a high vacuum environment and expensive equipment

Document EP0164492B1 discloses an active carbon system and the method of preparing the same where the molasses number test is used to characterize the product. The solution proposed comes with some advantages and disadvantages.

### Advantages:

Provides a measure of the adsorptive properties of the carbon material.
Can be used to compare the adsorption capacity of different carbon materials

### Disadvantages:

Not highly precise, as the results can be influenced by the concentration of the molasses solution and the duration of the test.
Does not provide information about the surface area or pore size distribution

Document Thang et al. “Methylene blue adsorption mechanism of activated carbon synthesised from cashew nut shells.” RSC advances 11.43 (2021): 26563-26570 discloses the use of methylene blue adsorption mechanism for evaluating the activated carbon synthesized. The solution proposed comes with some advantages and disadvantages.

### Advantages:

Can provide information about the pore size distribution and surface area of the carbon material.
Simple and straightforward to perform.
Relatively inexpensive

### Disadvantages:

The results can be affected by the concentration of the dye solution and the duration of the test
Does not provide direct information about the degree of activation of the carbon material

Document User Manual (https://embiodiagnostics.eu/wp-BELD content/uploads/2022/12/USR-01_Listeria-BELD-User-Manual-NEW-DEVICE-NEW-APP-for-customers.pdf) discloses the use of BELD device for Listeria monocytogenes detection. The solution proposed involves the use of BELD device along with specific manufactured biosensors for the detection of Listeria monocytogenes in dairy products.

The method and system of the present invention aims at improving the existing state of the art. In contrast to traditional methods, the method and system of the present invention relies on measuring actual porous material performance, in particular GAC filter performance on the basis of the obtained redox potential reading. The measurement data are uploaded to a cloud server where machine-learning algorithms process and interpret the obtained readings. The method and system proposed is easy to use anywhere and by anyone, the test is simple, quick and does not require laboratory conditions or special training. Results are available almost immediately.

### BRIEF DISCLOSURE OF THE INVENTION

The method and system of the present invention provide qualitative results that indicate if the porous material, such as used in a filter, in particular the GAC filter is still activated and working properly or is reaching/has reached the end of its life and needs to be changed. This optimises the timing of regeneration or replacement of the porous material. The system according to the present invention comprises a measuring device, which forms part of the present invention. The device's ease of use, reliable results, and quick action, offers an efficient and cost-effective added layer of precautionary safety measures for the industries of food safety, health and environmental monitoring and management. Then as already mentioned, the data without undergoing any processing is uploaded via the user's mobile device to the cloud where the processing of the data takes place using the mentioned machine learning algorithm. After processing, the result from the (ML) algorithm is returned to the user's mobile device where the user is informed about the status of the tested sample. A user interface, implemented in the mobile device, facilitates user interaction.

### LIST OF FIGURES

FIG. 1 is a general view of the system topology.

FIG. 2 illustrates the flow diagram of the algorithm.

FIG. 3 illustrates an exemplary embodiment of the invention based on the method kit.

FIG. 4 illustrates the weighing process.

FIG. 5 illustrates sample mixing.

FIG. 6 shows the filtering process.

FIG. 7 illustrates the placement of the electrode in the device.

FIG. 8 shows the activation of the device.

FIG. 9 illustrates the login to the application.

FIG. 10 illustrates the connection of the device to the application.

FIG. 11 illustrates the selection of measurement information.

FIG. 12 illustrates the process of performing the measurement.

FIG. 13 shows the end of the measurement and the display of the result.

FIG. 14 illustrates the start of a new measurement.

### DETAILED DISCLOSURE OF THE INVENTION

The invention is set out in the claims.

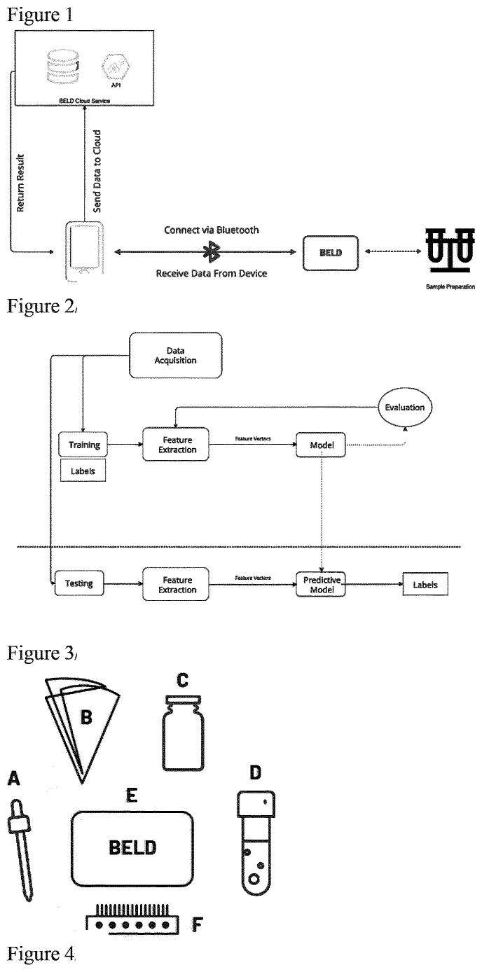

The general view of the system topology is illustrated in FIG. 1.

Before starting the measurement, the preparation of the sample takes place so that it comes in a form that the system can analyze. Then the processed sample is placed in the measuring device in which the measurement of the redox potential takes place. To perform the measurement, a mobile device is needed which simply serves as a user interface. The mobile device is connected via wireless connection, for instance Bluetooth to the measuring device for measuring the redox potential and receiving the measurement data. The measuring device takes a number of measurements per second, for instance 4 measurements per second for each one of 8 channels. Accordingly, in 1 minute of measurements, the data is for instance 240*8. Then the data without undergoing any processing is uploaded via the mobile device to the cloud where the processing of the data takes place using a machine learning algorithm. Alternatively, the data can be processed locally. After processing, the result from the (ML) algorithm is returned to the mobile device where the user is informed about the status of the tested sample. A user interface, implemented in the mobile device, facilitates user interaction.

The steps for implementation of the ML model are shown in FIG. 2 and explained below:
A. Data acquisition: The dataset consists of measurements from activated and non-activated samples. Each measurement consists of the data obtained by the 8 screen-printed electrodes that record the redox potential as a time series of potentiometric measurements (in Volts) and comprised 240 values per electrode (sampling rate of 4 Hz). The detected measurements were visualized through a voltage/time graph.
B. Training/Testing Dataset: The obtained dataset is split into training and testing dataset as follows: 80% is used for labeled training and 20% is used for testing. The training dataset is utilized to train the machine learning model and the testing dataset is utilized for the evaluation.
C. Processing/Feature Extraction: The processing of the dataset is performed in a two-step procedure. In the first step (preprocessing), starting noise is cleaned to smooth and calibrate the signal and the peak is determined. Then, all values are shifted to start at y=0 to minimize the noise that may present due to electrodes. In the second step (feature extraction), feature vectors are extracted from the cleaned data and used as input to develop an algorithm able to separate activated from non-activated samples. Each feature vector is calculated based on the following: (a) the average values (mean) for each cleaned dataset (b) the average value for a window size of 40 values after the peak (mean window), (c) the minimum rolling sum with a rolling window size of 50 (minimum sums) (d) the minimum rolling sum with a rolling window size of 5 for only 40 values after the peak (min sums window) and (e) the max value of the differences (max diffs). This procedure is applied in each electrode channel (channel 1, channel 2, etc.) and the overall test dataset ((a), (b), (c), (d) and (e) average for all 8 electrodes). Hence, from the initial experimental raw dataset with 240×8 values, only 1×45 (1 values for each channel (8 values in total)+1 overall value/(a), (b), (c), (d) and (e)) feature values are used for the sample discrimination and the model development.
D. Model: The algorithm uses the feature vectors from the previous step as input to train and test the model. The data is normalized so that each feature follows a normal distribution (Standard Normal Distribution) with a mean value of 0 and a standard deviation of 1. A Support Vector Machine (SVM) is used as an ML algorithm with a linear kernel.
E. Evaluation: the testing dataset is used for the evaluation of the model.

### DESCRIPTION OF EMBODIMENTS OF THE INVENTION

The invention is described below by way of a non-limiting implementation example and with reference to the attached figures, which show one embodiment of the object of the present invention.

A practical implementation of the method and system of the present invention is described below, as also presented in FIGS. 3 to 14. The implementation uses the BELD device as described in state-of-the-art Document BELD Manual.

More specifically, FIG. 3 illustrates a kit, including measuring device E, which uses open circuit potential and high-precision analog-to-digital converters to measure electrical signals, enabling high-performance control, parallel measurements, and high-speed testing. The system comprises a kit with a plastic pipette, filter paper, sample container, 8-channel electrode, and a disposable plastic test tube with distilled water.

With reference to FIG. 3, letters A to F correspond to the following:
A. Disposable plastic pipette
B. Filter paper 240 ø
C. Sample container 60 ml
D. 50 ml disposable plastic test tube with 50 ml distilled water
E. Measuring device, for instance B.EL.D Device
F. Electrode

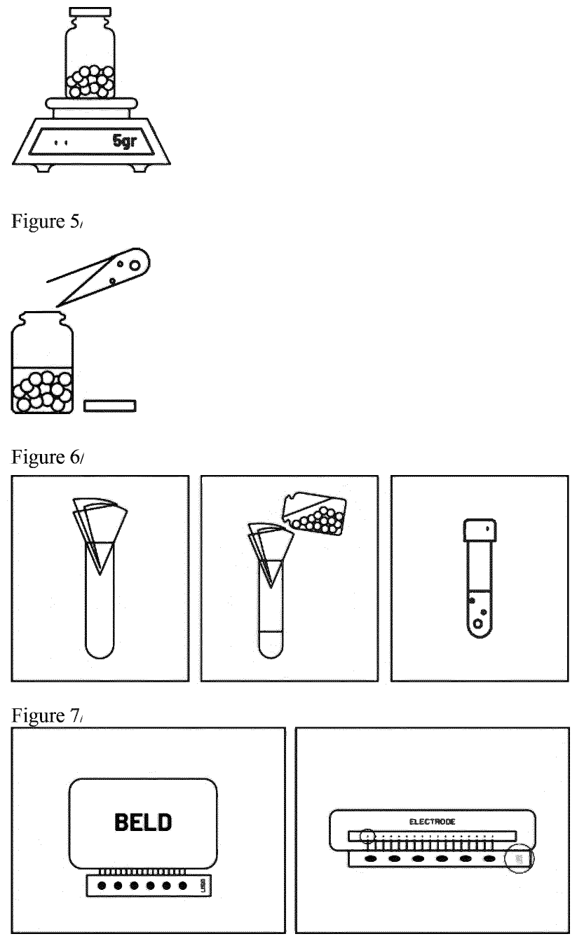

The following steps are necessary for sample preparation:
A. Weight 5 gr of dry carbon sample in the sample container (C) (FIG. 4)
B. Place the 50 ml of distilled water (D) in the sample container (C) and mix with the carbon (FIG. 5)
C. Place the filter paper 240 ø (B) into the 50 ml disposable plastic test tube (D) and filter the mixture from the sample container (C) (FIG. 6)

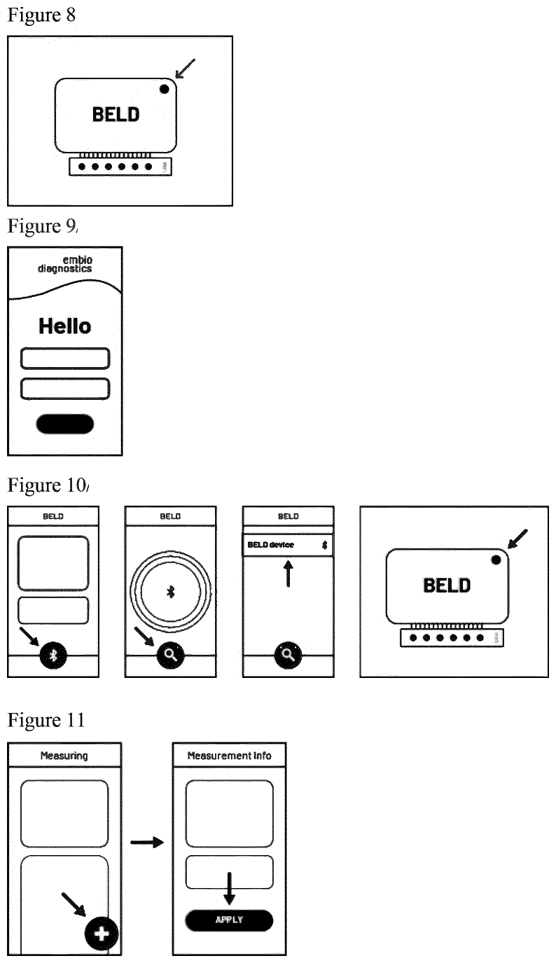

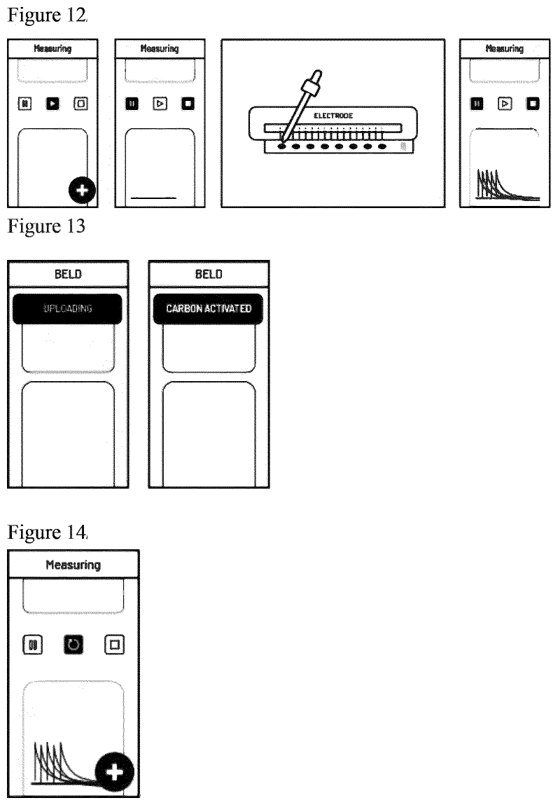

Subsequently and after the preparation of the sample has been carried out, the measurement takes place according to the following steps:
A. Remove the plastic cover of the electrode and connect the screen-printed electrode with the device. Be sure that the electrode is aligned with the pins of the connector. The logo on the electrode must be always on the user's right side (FIG. 7)
B. Press the multi-functional button of the device for approximate 8 seconds, until the led indicator becomes white. The device now is discoverable, the user can connect to the B.EL.D device using the mobile application according to the present invention (FIG. 8)
C. Turn on the Bluetooth functionality and location services on user's mobile phone, open the application and login (FIG. 9)
D. Press the Bluetooth button and then the search command and connect the application to the measuring device. Once the measuring device is connected to the application, the indicator becomes blue (FIG. 10)
E. Tap the “+” button and fill the measurements info in the appropriate fields (select your Category (Environment), Sample Type (Redox Potential) and Sample (Activated carbon)). Press Apply (FIG. 11)
F. START the measurement and then add two drops of the filtered sample onto each channel 1-8 with disposable plastic pipette (G) (FIG. 12)
G. After the END of the measurement, the result will appear on the user's mobile screen and the data will be uploaded automatically (FIG. 13)
H. For each new measurement press Restart and then press “+” to add new information for the next sample. The user will now be ready to start the next measurement (FIG. 14)

Then as already mentioned, the data without undergoing any processing is uploaded via the user's mobile device to the cloud where the processing of the data takes place using the mentioned machine learning algorithm. After processing, the result from the ML algorithm is returned to the user's mobile device where the user is informed about the status of the tested sample. A user interface, implemented in the mobile device, facilitates user interaction.

The implementation example described above is provided by way of illustration only and should not be construed to limit the invention. Those skilled in the art will readily recognize various modifications and changes that may be made to the present invention without following the examples and applications illustrated and described herein, and without departing from the scope of the present disclosure.

1. A method for checking and evaluating the activation performance of granulated carbon when used as a filter material, the method comprising the steps of:
obtaining a granulated sample of carbon;
dissolving said sample of carbon in a quantity of distilled water;
obtaining an extract by filtering said sample;
establishing a connection between a measuring device and a mobile device;
applying a quantity of said extract on a first plurality of pairs of electrodes on said measuring device;
obtaining a second plurality of measurements data by measuring the real-time redox potential between the said first plurality of pairs of electrodes of said measuring device;
establishing a connection between said mobile device and a cloud server;
uploading the second plurality of measurement data via wireless connections from said measuring device to said mobile device and from said mobile device to a cloud server;
processing said uploaded data with a machine learning algorithm;
downloading the result of the processing to the mobile device;
correlating the downloaded result with an activation performance measuring indication within the mobile device, thus producing an activation indication.

2. A method according to claim 1, whereby said machine learning algorithm comprises:
a step of data acquisition, whereby data are acquired from measurements from activated and non-activated samples;
splitting the data acquired into a training data set and a testing data set;
training said machine learning model with said training data set;
evaluating said machine learning model with said testing data set;
whereby the training of said machine learning model comprises:
processing said training data set to produce a feature vector set;
training said machine learning model with said feature vector set.

3. A method according to claim 1, whereby said filter material is any one of zeolites or ceramic material.

4. A method according to claim 1, whereby said activation indication is an activation percentage.

5. A system specially adapted for checking and evaluating the activation performance of granulated carbon when used as a filter material, the system comprising:
means for obtaining a granulated sample of carbon;
means for dissolving said sample of carbon in a quantity of distilled water;
means for obtaining an extract by filtering said sample;
means for establishing a connection between a measuring device and a mobile device;
means for applying a quantity of said extract on a first plurality of pairs of electrodes on said measuring device;
means for obtaining a second plurality of measurements data by measuring the real-time redox potential between the said first plurality of pairs of electrodes of said measuring device;
means for establishing a connection between said mobile device and a cloud server;
means for uploading the second plurality of measurement data via wireless connections from said measuring device to said mobile device and from said mobile device to a cloud server;
means for processing said uploaded data with a machine learning algorithm;
means for downloading the result of the processing to the mobile device;
means for correlating the downloaded result with an activation performance measuring indication within the mobile device, thus producing an activation indication.

6. A system according to claim 5, whereby the means for processing said uploaded data with a machine learning algorithm further comprises:
means for performing a step of data acquisition, whereby data are acquired from measurements from activated and non-activated samples;
means for splitting the data acquired into a training data set and a testing data set;
means for training said machine learning model with said training data set;
means for evaluating said machine learning model with said testing data set;
whereby the means for training of said machine learning model comprises:
means for processing said training data set to produce a feature vector set;
means for training said machine learning model with said feature vector set.

7. A system according to claim 5, whereby said filter material is any one of zeolites or ceramic material.

8. A system according to claim 5, whereby said activation indication is an activation percentage.
